(19) United States
(12) Patent Application Publication
(10) Pub. No.: US 2013/0017427 A1
(43) Pub. Date: Jan. 17, 2013

(54) ACCUMULATOR HAVING MULTIPLE ACCUMULATOR CELLS

(71) Applicants: Wolf Matthias, Stuttgart (DE); Thilo Koeder, Bayan Lepas (MY); Josef Baumgartner, Stuttgart (DE)

(72) Inventors: Wolf Matthias, Stuttgart (DE); Thilo Koeder, Bayan Lepas (MY); Josef Baumgartner, Stuttgart (DE)

(21) Appl. No.: 13/546,472

(22) Filed: Jul. 11, 2012

(30) Foreign Application Priority Data
Jul. 12, 2011 (DE) 102011079010.1

(51) Int. Cl. H01M 2/10

(52) U.S. Cl. 429/99

(57) ABSTRACT

In an accumulator having multiple accumulator cells situated in an accumulator housing, the end faces of the accumulator cells which face a specified housing section forming an end face plane, and at least one electrical line being fastened to at least one end face of at least one accumulator cell, the at least one accumulator cell being connected via the electrical line to an electronic component associated with the accumulator, at least one line routing element is situated, at least in sections, in the area of the end face plane between the end faces facing the specified housing section and the housing section, the line routing element having at least one guide element for guiding the at least one electrical line.

### CROSS REFERENCE

The present application claims the benefit under 35 U.S.C. §119 of German Patent Application No. DE 102011079010.1 filed on Jul. 12, 2011, which is expressly incorporated herein by reference in its entirety.

### FIELD OF THE INVENTION

The present invention relates to an accumulator having multiple accumulator cells situated in an accumulator housing, the end faces of the accumulator cells which face a specified housing section forming an end face plane, and at least one electrical line being fastened to at least one end face of at least one accumulator cell, the at least one accumulator cell being connected via the electrical line to an electronic component associated with the accumulator.

### BACKGROUND INFORMATION

Conventional accumulators may have multiple accumulator cells which are connected to one another in an electrically conductive manner via so-called cell connectors and interconnected to form packs or modules, and are therefore also frequently referred to as “accumulator packs.” The individual accumulator cells are generally welded to the cell connectors by electric spot welding, for example. The cell connectors are situated, at least in places, at end faces of the accumulator cells, and may be connected via electrical lines to electronic components which are associated with the accumulators, and may also be fastened to associated cell connectors as well as to end faces of corresponding accumulator cells, for example by soldering. In Li ion accumulators, for example, the electrical lines may be used to separately monitor and optionally control not only the state of charge of the accumulator as a whole, but also the state of charge of each individual accumulator cell in order to implement so-called single-cell monitoring.

A disadvantage is that in order to implement this type of single-cell monitoring, a plurality of electrical lines are laid in a corresponding accumulator or accumulator housing, resulting in complex and substantial wire harnesses which are difficult and cumbersome to handle. In addition, there is a risk of pinching one or multiple electrical lines during installation of the appropriately wired accumulator cells in an associated accumulator housing, for example during assembly of separate housing parts, or due to housing ribs provided inside the housing.

### SUMMARY

An object of the present invention, therefore, is to provide an accumulator having multiple accumulator cells situated in an accumulator housing, in which jamming or pinching of one or multiple electrical lines situated in the accumulator housing may be prevented during installation of the accumulator cells in the accumulator housing.

This object may be achieved by an example accumulator having multiple accumulator cells situated in an accumulator housing, the end faces of the accumulator cells which face a specified housing section forming an end face plane. At least one electrical line is fastened to at least one end face of at least one accumulator cell, the at least one accumulator cell being connected via the electrical line to an electronic component associated with the accumulator. At least one line routing element is situated, at least in sections, in the area of the end face plane between the end faces facing the specified housing section and the housing section, the line routing element having at least one guide element for guiding the at least one electrical line.

The present invention thus allows an accumulator to be provided in which jamming or pinching of the electrical lines situated inside an associated accumulator housing may be safely and reliably prevented by using an associated line routing element.

The line routing element is preferably designed as a line routing plate made of an at least flame-retardant material.

It is thus possible to provide a resistant, robust, and space-saving line routing element.

The line routing element is preferably detachably situated in the area of the end face plane.

An uncomplicated and quickly installable line routing element may be provided in this way.

Preferably at least two accumulator cells are connected to one another in an electrically conductive manner via a cell connector to which a further electrical line is fastened, the line routing element being supported, at least in sections, on the cell connector.

It is thus possible to provide a line routing element which is easily fixable to a cell connector.

According to one specific embodiment, the line routing element has at least one hold-down element. This hold-down element is preferably designed to prevent the electrical line from slipping out of the at least one guide element.

The present invention thus allows provision of a line routing element on which the electrical lines situated inside an associated accumulator housing are reliably and stably mounted.

The at least one guide element is preferably designed as a guide channel.

It is thus possible to provide a solid, reliable guide element.

According to one specific embodiment, the line routing element has at least one damping element. This damping element is preferably designed to at least damp impacts of the end faces facing the specified housing section against the housing section during relative motions between the accumulator cells and the accumulator housing.

The present invention thus allows an accumulator to be provided in which damage to the accumulator cells during relative motions between the accumulator cells and the accumulator housing may be easily prevented.

According to one specific embodiment, at least one positioning element, to which the line routing element is detachably fastenable, is provided.

The present invention thus allows an accumulator to be provided in which the line routing element is easily installable in a quick and precise manner.

At least a portion of the accumulator cells are preferably supported in a housing filling structure, the at least one positioning element being provided on the housing filling structure.

Uncomplicated and cost-effective implementation of the positioning element is thus made possible.

The at least one positioning element preferably has a pin-shaped design on the housing filling structure, and the line routing element has at least one recess for accommodating the positioning element.

A simple and stable arrangement of the line routing element on the housing filling structure is thus made possible.

### BRIEF DESCRIPTION OF THE DRAWINGS

The present invention is explained in greater detail below, with reference to exemplary embodiments illustrated in the figures.

FIG. 1 shows a perspective illustration of an accumulator provided with an associated accumulator housing and having a line routing element according to the present invention.

FIG. 2 shows a side view of the accumulator from FIG. 1.

FIG. 3 shows a first sectional view of the accumulator from FIGS. 1 and 2, viewed in the direction of arrows III in FIG. 2.

FIG. 4 shows a second sectional view of the accumulator from FIGS. 1 and 2, viewed in the direction of arrows IV in FIG. 2.

### DETAILED DESCRIPTION OF EXAMPLE EMBODIMENTS

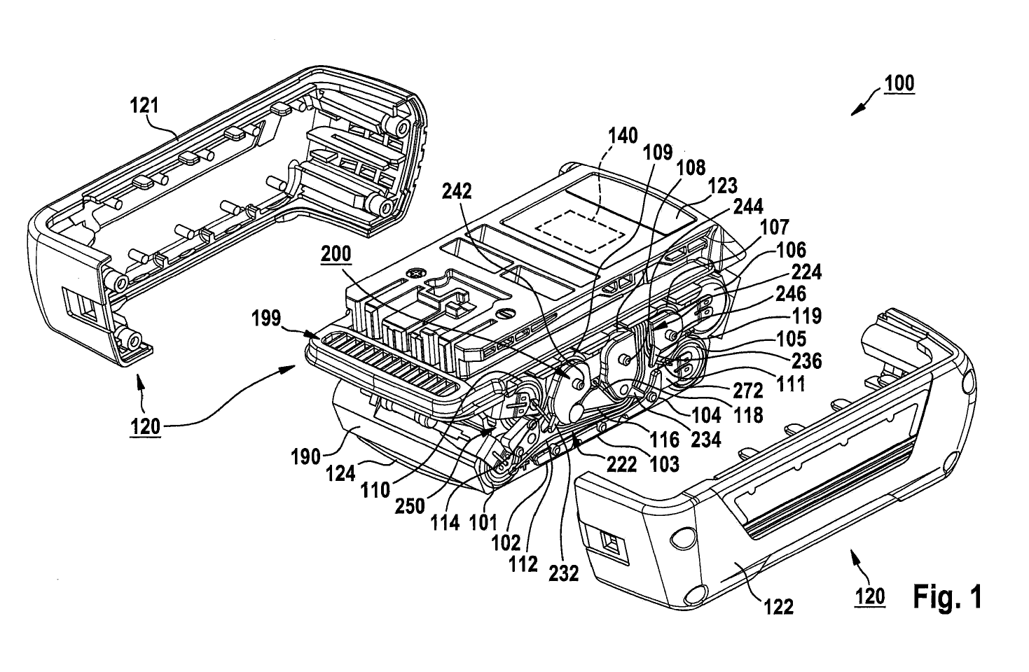

FIG. 1 shows an accumulator 100, designed as an interchangeable accumulator pack, for example, having an accumulator housing 120, which as illustrated is composed of four housing sections 121, 122, 123, 124 which are fastenable to one another. These housing sections are fastenable to one another via associated locking, snap, and/or screw connections, for example, which are well known to those skilled in the art, so that a detailed description may be dispensed with here for the sake of simplicity and brevity of the description.

Accumulator 100 has, for example, one electronic component 140 and ten accumulator cells 101, 102, 103, 104, 105, 106, 107, 108, 109, 110, and is mechanically and electrically connectable via an interface 199, for example, to an associated electrical device for supplying power to this electrical device independently from the power network. Electronic component 140 has, for example, a protective circuit for accumulator 100 or electronic components for implementing single-cell monitoring and/or connecting elements associated with interface 199 for contacting the associated electrical device.

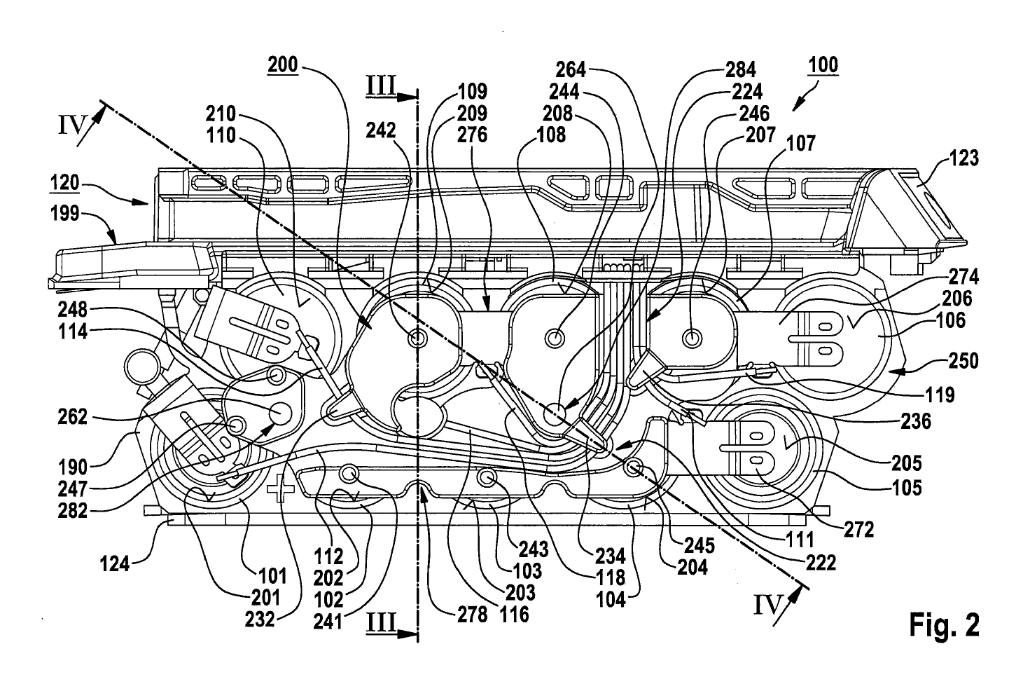

As illustrated, accumulator cells 101, 102, 103, 104, 105, 106, 107, 108, 109, 110 have a cylindrical design, and at their axial ends have cell heads which define end faces facing housing sections 121, 122, as an example end faces (201, 202, 203, 204, 205, 206, 207, 208, 209, 210 in FIG. 2) which face housing section 122 forming an end face plane 250. To interconnect accumulator cells 101, 102, 103, 104, 105, 106, 107, 108, 109, 110 to form a pack or module in an application-specific manner, specified cells may be connected to one another in an electrically conductive manner at their cell heads via corresponding cell connectors. For example, accumulator cells 104, 105 are connected to one another in an electrically conductive manner via a cell connector 272.

According to one specific embodiment, at least one electrical line is fastened, at least in the area of an end face of at least one accumulator cell, for example by soldering, the at least one accumulator cell being connected to electronic component 140 via the electrical line. In this regard, the electrical line may be fastened directly to the end face, or also to a cell connector which is fastened to the end face. For example, six electrical lines 111, 112, 114, 116, 118, 119 are provided, electrical line 114, for example, being fastened in the area of the end face (210 in FIG. 2) of accumulator cell 110, and electrical line 111 being fastened to cell connector 272 which connects the end faces (204, 205 in FIG. 2) of accumulator cells 104, 105 to one another.

As illustrated, at least a portion of accumulator cells 101, 102, 103, 104, 105, 106, 107, 108, 109, 110 is supported in a housing filling structure 190 which is preferably suited for heat dissipation. This housing filling structure encloses, for example, the lateral surfaces of all accumulator cells 101, 102, 103, 104, 105, 106, 107, 108, 109, 110, and leaves their cell heads free to allow an electrically conductive connection with corresponding cell connectors (272, for example) or associated electrical lines (111, 114, for example) via the cell heads.

According to one specific embodiment, a line routing element 200 is detachably situated, at least in sections, in the area of end face plane 250 between the end faces (201, 202, 203, 204, 205, 206, 207, 208, 209, 210 in FIG. 2) of accumulator cells 101, 102, 103, 104, 105, 106, 107, 108, 109, 110 facing housing section 122 and housing section 122. Alternatively, line routing element 200 could also be glued to the end faces (201, 202, 203, 204, 205, 206, 207, 208, 209, 210 in FIG. 2) of accumulator cells 101, 102, 103, 104, 105, 106, 107, 108, 109, 110, or could be designed as a self-adhesive component.

Line routing element 200 is preferably made of an elastic material which is preferably flame-resistant and at least flame-retardant. For example, line routing element 200 may be made of a thermoplastic elastomer which is flame-resistant and flame-retardant as the result of suitable chemical additives. However, it is pointed out that the use of this type of material is described strictly as an example, and is not to be construed as limiting the present invention. This line routing element may also be made of alternative materials, for example nonelastic materials.

According to one specific embodiment, line routing element 200 is used for guiding electrical lines 111, 112, 114, 116, 118, 119. For this purpose, these electrical lines may be bundled into wire harnesses and/or guided separately on line routing element 200. A separate cable guide could advantageously be used to reduce a corresponding risk of short-circuiting.

As illustrated, line routing element 200 has one or multiple guide elements for guiding electrical lines 111, 112, 114, 116, 118, 119. For example, two guide elements designed as guide channels are denoted by reference numerals 222, 224, electrical lines 111, 112, 114, 116, 118, 119 being guided, at least in sections, in the guide elements. In addition, three hook-shaped hold-down elements or tabs 232, 234, 236 for suspending electrical lines 111, 112, 114, 116, 118, 119 are provided on line routing element 200, and are designed to prevent electrical lines 111, 112, 114, 116, 118, 119 from sliding out of guide channels 222, 224. However, it is pointed out that hold-down elements 232, 234, 236 are strictly an example, and are not to be construed as limiting the present invention. Alternatively or additionally, these hold-down elements may be implemented with the aid of an adhesive mounting, for example, via which electrical lines 111, 112, 114, 116, 118, 119 may be glued in guide channels 222, 224.

In addition, as illustrated, a plurality of pin-shaped damping elements 242, 244, 246 (and 241, 243, 245, 247, 248 in FIG. 2) is provided on line routing element 200. These damping elements may, for example, abut on specified housing section 122, and are designed to at least damp impacts of the end faces (201, 202, 203, 204, 205, 206, 207, 208, 209, 210 in FIG. 2) facing housing section 122 against this housing section 122 during relative motions between accumulator cells 101, 102, 103, 104, 105, 106, 107, 108, 109, 110 and accumulator housing 120, for example when vibrations occur during operation of the associated electrical device.

FIG. 2 shows end face plane 250 of accumulator 100 of FIG. 1 together with accumulator cells 101, 102, 103, 104, 105, 106, 107, 108, 109, 110, line routing element 200 in FIG. 1 being situated on end faces 201, 202, 203, 204, 205, 206, 207, 208, 209, 210 of the accumulator cells facing housing section 122 in FIG. 1, as illustrated. FIG. 2 illustrates guide channels 222, 224 of line routing element 200 in which electrical lines 111, 112, 114, 116, 118, 119 are guided, at least in sections, and their hold-down elements 232, 234, 236 for fixing electrical lines 111, 112, 114, 116, 118, 119 in guide channels 222, 224. In addition, FIG. 2 illustrates damping elements 242, 244, 246 of line routing element 200, as well as further pin-shaped damping elements 241, 243, 245, 247, 248 as examples.

According to one specific embodiment, line routing element 200 is designed as a one-piece line routing plate, which as an example is supported, at least in sections, on cell connector 272 in FIG. 1 and also on further cell connectors 274, 276, 278. However, it is pointed out that line routing element 200 may alternatively be designed in multiple parts, i.e., composed of two or more segments, for example in order to simplify an appropriate installation of line routing element 200 on accumulator cells 101, 102, 103, 104, 105, 106, 107, 108, 109, 110, or to allow equipping differently designed accumulators using an assortment of various line routing element components.

As illustrated, cell connector 274 connects accumulator cells 106, 107, cell connector 276 connects accumulator cells 108, 109, and cell connector 276 connects accumulator cells 108, 109 to one another in an electrically conductive manner. As an example, electrical line 119 is fastened to cell connector 274, electrical line 118 is fastened to cell connector 276, and electrical line 116 is fastened to cell connector 278. Electrical line 112 is fastened, for example, in the area of end face 201 of accumulator cell 101.

According to one specific embodiment, positioning elements 262, 264 are provided for positioning line routing element 200 in the area of end face plane 250. These positioning elements have a pin-shaped design, for example, on housing filling structure 190 in FIG. 1, and after appropriate installation engage with associated recesses or openings 282, 284, which, as illustrated, are provided on line routing element 200.

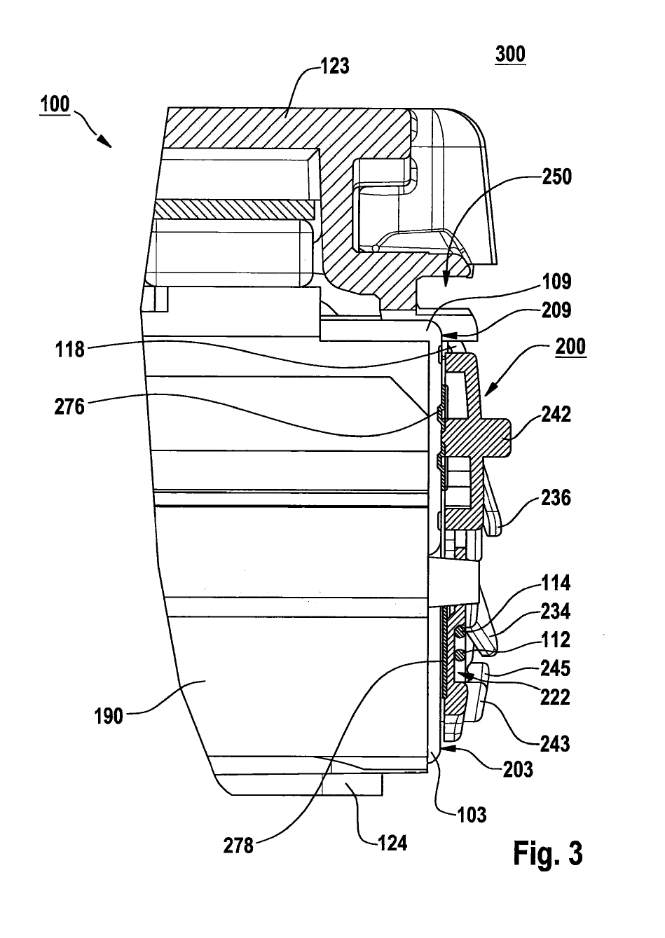

FIG. 3 shows a detail 300 of accumulator 100 from FIGS. 1 and 2 for illustrating guide channel 222, damping element 242, and hold-down elements 234, 236 of line routing element 200. FIG. 3 also illustrates cell connectors 276, 278.

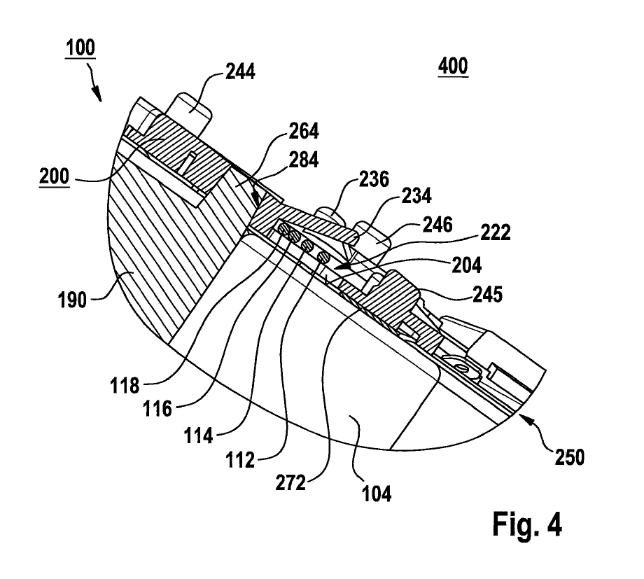

FIG. 4 shows a detail 400 of accumulator 100 from FIGS. 1 and 2 for illustrating positioning element 264 which is provided on housing filling structure 190 and which is situated in recess 284 in line routing element 200, as well as damping element 245 from FIGS. 1 and 2. In addition, FIG. 4 illustrates hook-shaped hold-down element 234, which prevents electrical lines 112, 114, 116, 118 from slipping out of guide channel 222.

What is claimed is:

1. An accumulator, comprising:
an accumulator housing;
multiple accumulator cells situated in the accumulator housing, end faces of the accumulator cells which face a specified housing section of the accumulator housing forming an end face plane;
at least one electrical line fastened to at least one end face of at least one of the accumulator cell, the at least one accumulator cell being connected via the electrical line to an electronic component associated with the accumulator; and
at least one line routing element situated, at least in sections, in an area of the end face plane between the end faces facing the specified housing section and the housing section, the line routing element having at least one guide element for guiding the at least one electrical line.

2. The accumulator as recited in claim 1, wherein the line routing element is a line routing plate made of an at least flame-retardant material.

3. The accumulator as recited in claim 1, wherein the line routing element is detachably situated in the area of the end face plane.

4. The accumulator as recited in claim 1, wherein at least two of the accumulator cells are connected to one another in an electrically conductive manner via a cell connector to which a further electrical line is fastened, the line routing element being supported, at least in sections, on the cell connector.

5. The accumulator as recited in claim 1, wherein the line routing element has at least one hold-down element which is configured to prevent the electrical line from slipping out of the at least one guide element.

6. The accumulator as recited in claim 1, wherein the at least one guide element is a guide channel.

7. The accumulator as recited in claim 1, wherein the line routing element has at least one damping element which is configured to at least damp impacts of the end faces facing the specified housing section against the housing section during relative motions between the accumulator cells and the accumulator housing.

8. The accumulator as recited in claim 1, further comprising:
at least one positioning element to which the line routing element is detachably fastened.

9. The accumulator as recited in claim 1, wherein at least a portion of the accumulator cells is supported in a housing filling structure, the at least one positioning element being provided on the housing filling structure.

10. The accumulator as recited in claim 9, wherein the at least one positioning element has a pin-shaped design on the housing filling structure, and the line routing element has at least one recess which is for accommodating the positioning element.
